(19) United States
(12) Patent Application Publication
(10) Pub. No.: US 2022/0254114 A1
(43) Pub. Date: Aug. 11, 2022

(54) SHARED MIXED REALITY AND PLATFORM-AGNOSTIC FORMAT

(71) Applicant: CITA Equity Partners, LLC, Nacogdoches, TX (US)

(72) Inventors: John Garrett Frederick, Nacogdoches, TX (US); Bhavin Tarunbhai Machchhar, Rajkot (IN); Sanjay Gordhanbhai Changani, Rajkot (IN)

(21) Appl. No.: 17/666,816

(22) Filed: Feb. 8, 2022

Related U.S. Application Data
(60) Provisional application No. 63/147,231, filed on Feb. 8, 2021.

(51) Int. Cl. G06T 19/00; G06T 13/20; G06T 15/10; H04L 67/131

(52) U.S. Cl. CPC G06T 19/006; G06T 13/20; G06T 15/10; G06T 2200/24; G06T 2219/024; G06T 2200/16; H04L 67/38

(57) ABSTRACT

A shared reality system is described here that defines a platform-agnostic format for three-dimensional objects for use with AR and VR and projects these objects into VR and AR worlds that can be seen by multiple users at the same time. Each user can see the same object and the object may contain shared information that an operator of the system wants everyone to see, such as scores, advertisements, offers, or status information. Rather than having separate individual experiences, each user sees the same virtual objects as if they were present in the real world. The format used for displaying the AR and VR content is compatible with a wide variety of device types, so that content creators can focus on their content and ignore platform differences. Thus, the shared reality system makes it easy for content creators to create shared reality experiences across a wide variety of devices.

### CROSS-REFERENCE TO RELATED APPLICATIONS

The present application claims the benefit of U.S. patent application Ser. No. 63/147,231 (Attorney Docket No. FREDERICK001) entitled “SHARED REALITY AND COMMON FORMAT,” and filed on 2021 Feb. 8, which is hereby incorporated by reference.

### BACKGROUND

Virtual reality (VR) is a simulated experience that can be like or completely different from the real world. Applications of virtual reality include entertainment (e.g., video games) and education (e.g., medical, or military training). Currently, standard virtual reality systems use either virtual reality headsets or multi-projected environments to generate realistic images, sounds, and other sensations that simulate a user's physical presence in a virtual environment. A person using virtual reality equipment can look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic and other technology.

Augmented reality (AR) is an interactive experience of a real-world environment where the objects that exist in the real world are enhanced by computer-generated perceptual information, sometimes across multiple sensory modalities, including visual, auditory, haptic, somatosensory, and olfactory. Whereas a person using VR typically does not see what is going on in the real world, a person using AR sees the real world and virtual objects projected into it. AR can be defined as a system that fulfills three basic features: a combination of real and virtual worlds, real-time interaction, and accurate 3D registration of virtual and real objects. The overlaid sensory information can be constructive (i.e., additive to the natural environment), or destructive (i.e., masking of the natural environment). This experience is seamlessly interwoven with the physical world such that it is perceived as an immersive aspect of the real environment. In this way, augmented reality alters one's ongoing perception of a real-world environment, while virtual reality completely replaces the user's real-world environment with a simulated one.

Several types of devices are available today for experiencing virtual and augmented reality. For example, dedicated headsets exist such as the Oculus Rift, Oculus Quest, Oculus Go, HTC Vive, PlayStation VR, and Samsung Gear. Some companies have recognized that existing devices, such as smartphones, have sufficient screen resolution to function as VR headsets and have produced holders for these devices, such as Google Cardboard, which is a cardboard holder that holds a phone to the eyes to function as a VR headset. Many smart devices can also be used directly as AR devices, such as the Apple iPhone, Google Android phones, Apple iPad, other tablets, and so forth. AR devices have one or more cameras for capturing the real world, and then display the captured image and desired augmented images on the device's display. Some devices, such as the latest versions of Apple's iPhone and iPad, incorporate LIDAR scanners for capturing a 3D model of the real world into which virtual objects can be rendered.

Unfortunately, each of the devices used for VR and AR typically use proprietary formats for defining three-dimensional data and it is difficult to create experiences that can be easily shared across multiple platforms. In addition, VR and AR are typically individual experiences that take the user away from the real world and their social contacts. While some work has been done to mirror what a user sees in VR to a nearby TV so that others can watch, VR is still largely a solo experience. Likewise, while AR games have been developed, such as Pokémon Go, where users all share common goals and collect virtual items projected into the real world, each user is still viewing an individualized experience unique to that user. Playing together more refers to having similar individual experiences than to seeing the same virtual world and being able to interact together in it. VR also allows for certain types of shared individual experiences, such as chat rooms where users can meet virtually or concerts where users can watch the same performance, but each user is still having a distinct experience and seeing a different view of the performance.

### BRIEF DESCRIPTION OF THE DRAWINGS

FIG. 1 is a block diagram that illustrates components of the shared reality system, in one embodiment.

FIG. 2 is a flow diagram that illustrates processing of the shared reality system to render mixed reality virtual objects from a platform-agnostic storage format on a user's specific device, in one embodiment.

FIG. 3 is a flow diagram that illustrates processing of the shared reality system to store a shared mixed reality experience created by a content creator for multiple users, in one embodiment.

### DETAILED DESCRIPTION

A shared reality system is described here that programmatically creates a platform-agnostic format for three-dimensional objects for use with AR and VR and projects these objects into VR and AR worlds that can simulate being seen by multiple users at the same time. For example, people at a real sporting event can use their smartphone or other device to see augmented reality objects, such as a virtual Jumbotron projected at the center of the venue. Each user perceives seeing the same object through their individual devices simultaneously and the object may hold shared information that an operator of the system wants everyone to see, such as scores, advertisements, offers, or status information. Rather than having separate individual experiences, each user perceives seeing the same virtual objects as if they were present in the real world. Just as a real Jumbotron often sits in the middle of a sports venue and displays information that anyone at the venue can look up and see, the shared reality system displays virtual objects to any user at the location that loads the system. In addition, the format used for displaying the AR and VR content is compatible with a wide variety of device types, so that content creators can focus on their content and ignore platform differences. Thus, the shared reality system makes it easy for content creators to create shared reality experiences across a wide variety of devices.

### Shared Experience

In some embodiments, the shared reality system includes a hosting platform and a viewer application. The hosting platform runs on a server, such as a dedicated or cloud-based hosted server, and stores information about what virtual objects users of the system can interact with. For example, the hosting platform may store virtual objects by location (e.g., GPS or other data) where they are to be displayed, time when they are to be displayed and for how long, users that are allowed to see the objects (e.g., everyone or authorized via paid subscription), and so forth. The hosting platform may also store profile information for users, such as contact information, subscription information, login information, and so on. The viewer application runs on devices capable of displaying VR and/or AR, such as a smartphone, and displays the virtual objects to the user overlaid in the specified real-world location. The viewer application runs on the user's device and may use local hardware of the device, such as the device's camera(s), scanner(s), screen, GPS hardware, and so forth. The viewer application may also store user login credentials to login to the hosting platform and access stored user profile information to customize the experience for each user.

In some embodiments, the shared reality system supplies transparent augmented reality geometric shapes of varying sizes that can be nested within each other creating layers. For example, an outer shape could be a box that coincides with a room in the real world, and when the user enters the box/room, more shapes are shown nested inside. For example, a user might enter a room and be shown a treasure box, which the user could then open and see more objects/shapes. The geometric shapes can have varying degrees of opacity, such that they appear solid, transparent, or some level in between. This can allow the user to see through the objects to underlying real world or virtual objects. The geometric shapes can also be dynamic or static, independent of each other. For example, to better catch the user's attention the system might display a rotating object or a scrolling banner.

In some embodiments, the shared reality system allows images and videos to be applied to and seen on the geometric shapes. For example, a virtual Jumbotron might display an instant replay video of a significant play at a sporting event, or a better view of the artist at a concert. Text or logos can also be applied and seen on the geometric shapes. For example, advertisements might be displayed on a real-world object, such as a side of a building, statue, street, or other object, and may have company logos and text for selling a product or guiding users to a store where users can buy products.

In some embodiments, interacting with shapes and objects produced by the shared reality system can trigger an action such as an audible sound, visual stimulus, or tactile vibration. For example, touching a virtual object that looks like a button may cause the object to appear depressed and make a clicking sound like a real button would. Alternatively or additionally, touching a virtual object may cause a new object to be displayed or trigger a reaction such as a confetti explosion.

The shared reality system provides various methods and systems for creating three-dimensional objects and introducing these objects into multi-dimensional data captured from the real world. The blend of real world captured data and created objects is then displayed on diverse types of multi-dimensional devices, from headsets capable of showing three dimensions, to smartphones with two dimensional screens. The system programmatically creates and projects geometric objects as well as uses other standard formatted objects in three-dimensional space into captured real world data for digital rendering over a network and projecting third party content onto the geometric objects using them as an augmented reality viewing screen creating an augmented reality viewing experience of digital media and data. For example, the jumbotron is using a USDZ object. The system programmatically creates other geometric objects such as cubes with advertising or logos applied to them and all can be seen in the same viewfinder together by the user.

The shared reality system enables multiple users to share multimedia content as three-dimensional objects by providing a function of authoring three-dimensional objects, providing a robust interactive experience for a user through augmented reality implementation, and allowing a user to receive a content object from a remote server to augment the user's real-world experience at the user interface of a viewing application.

The shared reality system includes applications for content creators to create content and for viewing users to view content managed by the system. The creator application allows a creator to define the virtual objects to be displayed to users, including each object's shape, function, location to be displayed, which users can see the object, and so forth. The viewing application provides a user interface, a generator for selecting geometric AR objects that are each formatted for the user's particular AR rendering viewing experience and blends the objects to be displayed with captured real-world camera, scanner, and GPS data to produce the augmented display defined by the creator. The viewer application may receive three-dimensional objects defined in a platform-agnostic format from the hosting platform and may then render these objects in the proper augmented locations alongside real-world objects.

In some embodiments, the system uses a combination of USDZ or other common 3-D files and programmatically (in software) creates objects that can all be viewed together. Note that users do not actually see the same objects (because they do not really exist), but the system creates the perception of users seeing the same object (like the jumbotron) in the same location from each of their own devices. In some embodiments, the system allows the creation and sharing of gallery content in an AR environment between users. This allows one user to create something that is then uploaded and posted to a location that other users can download and view the content on their own devices in an AR environment.

### Platform-Agnostic Format

In recent times, advances in computing power have enabled computing systems to provide new and varied experiences to users. One such category of new and varied user experiences relates to the areas of computer-enhanced realities. For example, augmented reality (AR) is a live, direct, or indirect view of a physical, real-world environment whose elements are augmented (or supplemented) by computer-generated sensory input such as sound, video, graphics, or GPS data. Augmented reality uses a user's existing reality and adds elements to it when viewed via a computing device, display, or projector of some sort. For example, many mobile electronic devices, such as smartphones and tablets, can overlay digital content into the user's immediate environment through use of the device's camera feed and associated viewer. Thus, for example, a user could view the user's real-world environment through the display of a mobile electronic device while virtual objects are also being displayed on the display, thereby giving the user the sensation of having virtual objects together with the user in a real-world environment.

Virtual reality (VR) is another example of a computer-implemented reality. In general, VR refers to computer technologies that use reality headsets and/or other peripheral devices to generate sounds, images, and other sensations that replicate a real environment or that form an imaginary world. Virtual reality immerses a user in an entirely virtual experience and allows the user to interact with the virtual environment.

Another example of a computer-implemented reality is a hybrid reality called mixed reality (MR). Mixed reality is the merging of real and virtual worlds to produce new environments and visualizations where physical and digital objects coexist and interact in real time. Many MR implementations place new imagery within a real space and often do so in such a way that the new imagery can interact with what is real in the physical world. For example, in the context of MR, a user may view a whiteboard through an MR-enabled headset and use a digitally produced pen (or even a capped physical pen) to write on the white board. In the physical world, no writing appears on the whiteboard but within the MR environment the user's interaction with a real-world object causes a digital representation of the writing to appear on the whiteboard. In MR systems, some synthetic content can react and/or interact with the real-world content in real time.

Extended Reality (XR) is an umbrella term, often used synonymously for each of the forms of computer-generated reality content—AR, VR, and MR. As used here, the term “extended reality” or “XR” refers to all real and virtual combined environments and human-machine interactions generated by computer technology and wearables. Extended reality includes all its descriptive forms, such as digital representations made or displayed within AR, VR, or MR. Extended reality experiences are a recent development, and as a result, many different entities are each developing their own XR rendering platforms and capabilities. For example, Apple Corporation has a rendering platform known as ARKit, which uses AR object files in the USDZ format to provide AR experiences to a user. Android Corporation provides the ARCore platform and uses SFB files to provide AR user experiences to a user. Other platforms use the GLTF AR object file format to provide AR user experiences to a user.

However, even though a group of platforms may use a single object file format (e.g., GLTF, SFB, or USDZ), there is a lack of file format standardization that leads to incompatibility between platforms and even within different versions or operating parameters of the same platform. For example, a GLTF AR object file format may render the desired AR content when provided to a given platform's AR viewer, but on a different platform's AR viewer or even within different versions of the AR viewer the AR content may be rendered improperly. That is, a GLTF file created for one platform is often not suitable for a different platform that uses the same file type.

Thus, if an entity wishes to provide a uniform XR experience across a number of different platforms, such an endeavor can be particularly difficult. In particular, the entity may need to develop a number of different XR object files in varying formats to be able to meet the needs of the various XR platforms. Further, as each platform or operating environment is updated, the associated object files may similarly require an update to function properly. This places a burden on providers of XR content and can complicate the generation, storage, and recovery of the correct object file at each implementation. This may be particularly difficult for novice users who have little technical knowledge on how to create and/or modify AR files. So, there are a number of disadvantages with the acquisition, generation, and intelligent distribution of XR content that can be addressed.

The shared reality system solves the foregoing problems with the acquisition, generation, and intelligent distribution of XR content programmatically using software running on the users' devices and hosted servers. One or more implementations can include a method for creating XR content from common media (pictures and video) captured on common devices and applying those images to a programmatically generated three-dimensional object, thereby avoiding the issues created by the differing file types used for three-dimensional objects used in XR experiences.

For example, a method for providing AR content can include a number of acts performed in a computing device, including a) capturing or receiving media files, b) programmatically rendering a geometric 3D object, c) receiving user input modifying the 3D object, d) creating a plurality of varying-sized same-shaped 3D geometric objects using the same anchor point creating layers of embedded programmatically generated 3D AR screens e) applying media content to one or more of the 3D AR object layers for viewing on the user device creating an XR experience f) creating a universal link pointing to an endpoint at the server, the endpoint including logic to determine which of the plurality of 3D AR objects to render along with the associated media content file to provide to an entity accessing the universal link, g) providing the universal link to the user interface where the universal link is operable at an end user device to enable an end user of the end user device to navigate to the endpoint at the server by accessing the universal link, h) receiving a request for 3D AR experience as a result of the universal link being shared and selected at an end user device, and i) determining, by the logic and based on the XR rendering platform which experience to render to the requesting device.

In some embodiments, the shared reality system sends a determined 3D AR experience to the end user device that is operable to render a 3D AR experience at the end user device, the programmatically generated 3D AR object being compatible with one or more of the AR viewer, a version of the AR viewer, a browser type, a version of the browser type, an operating system, or a version of the operating system on the end user device. Advances in the Google Chrome and Apple Safari browsers have also made possible the sharing of AR content across platforms. Users can share media (pictures and videos) via a common link, and the people receiving or selecting the link to the picture/video will see the media in an AR experience on their device without having to download a dedicated viewing application.

### ILLUSTRATED EMBODIMENTS

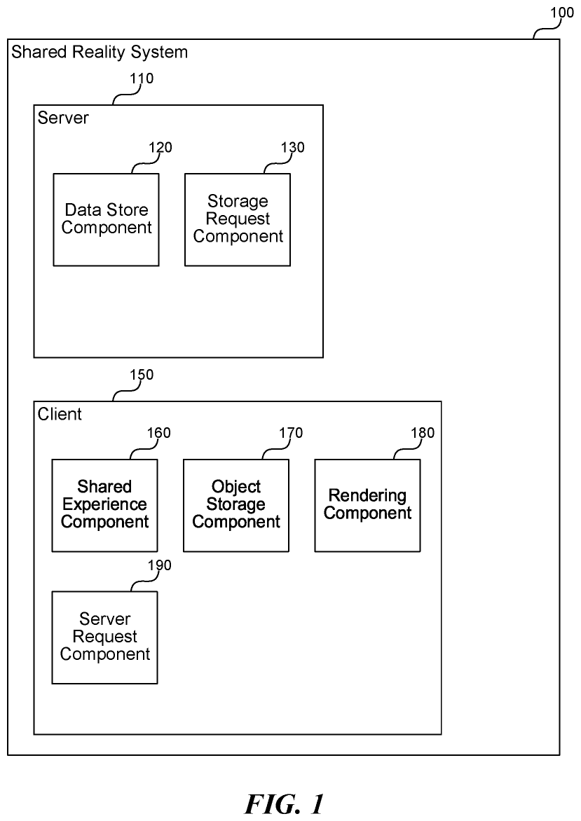

FIG. 1 is a block diagram that illustrates components of the shared reality system, in one embodiment. The system 100 includes one or more servers 110 and one or more clients 150. The servers 110 include a data store component 120 and a storage request component 130. The clients 150 include a shared experience component 160, an object storage component 170, a rendering component 180, and a server communication component 190. Each of these components is described in further detail here.

In some embodiments, the shared reality system 100 uses a client/server architecture in which one or more servers 110 receive requests from one or more clients 150 to store and access data for producing shared reality experiences across the world.

The data store component 120 stores virtual objects in a platform-agnostic format supported by different operating systems and device types. The data store may include one or more hard drives, cloud-based storage services (e.g., Amazon S3), network attached storage (NAS) devices, storage area networks (SANs), databases, file servers, or other data storage device that can manage client requests to store and retrieve virtual objects. The data store component 120 may also encompass a content delivery network (CDN) that optimizes the storage and retrieval of virtual objects for clients on a variety of networks and in a variety of geographic or network topographic locations. For example, virtual objects may be mirrored on a server in China for users in that country to receive lower latency access to the system while the same or other virtual objects are mirrored to a different server in the United States for users in that country to access.

The storage request component 130 receives requests from one or more clients to store and retrieve virtual objects stored in a platform-agnostic format. The storage request component 130 may employ strategies to load balance client requests so that requests from all clients are not handled by the same server. Thus, the storage request component 130 may consist of a hierarchy or network of servers, front doors, backend systems, and so forth that handle client requests and do the work of storing virtual objects on behalf of each client and retrieving those virtual objects for requesting clients. The storage request component 130 may use a web or other application-programming interface (API), such as a representational state transfer (REST) API, to provide clients with a uniform way of accessing server-side data and functionality.

The shared experience component 160 determines which users are part of the same shared experience and renders similar content for each user in the same shared experience to produce a similar display of mixed reality objects. Three-dimensional rendering typically has a concept of a camera or viewing position from which the user is viewing the content. In the real world, if two people are sitting on opposite sides of a room, the same objects exist in the room, but each person sees a different view of the objects based on each person's position in the room. Likewise, in a virtual or physical-plus-virtual (augmented) world, two users can be in the same “room” but have a different view or camera angle within the room.

Consider a virtual Jumbotron displayed in an augmented view of a real soccer field. User A may see the North side of the Jumbotron, while User B may see the South side of the Jumbotron because they are sitting on opposite sides of the field. They are having a shared experience, because they are at the same location (the soccer field) and seeing the same augmented reality object (the virtual Jumbotron), but they also see different sides of that object. The shared experience component 160 handles these commonalities and differences, by rendering the same virtual objects for each user but also considering each user's unique viewing location of the virtual objects to render an appropriate view or angle of each object.

The object storage component 170 converts device-specific representations of AR and VR virtual objects into a platform-agnostic format supported by different operating systems and device types. The object storage component 170 is used when virtual objects are created by a content creator and the content creator requests to store the objects on the server. The shared reality system may include multiple applications, such as a creator application that content creators use to create and store shared experiences, and an experience application that consuming users run to view and experience the shared experiences the content creators have made for them. Content creators may use a variety of open and proprietary tools for creating three-dimensional content, but the object storage component 170 handles the conversion of three-dimensional content into a platform-agnostic format that can be later rendered on a variety of device types, operating systems, and platforms.

The object storage component 170 may utilize a filter or plug-in architecture that allows for the later addition of formats not originally supported by the system to be added so that the system can store data from these formats in the platform-agnostic format and provide them to diverse client devices. As new content creation tools and corresponding formats are developed and content creator preferences change, the system 100 can continue to stay up to date to convert virtual objects created with such tools into a platform-agnostic format for use with the system 100 to provide the many benefits described here.

Virtual objects may have movement and or interactivity that is stored with the object for rendering by clients. For example, a virtual object may be defined to rotate or follow a particular pattern of movement when it is rendered into a virtual world. An object may also be defined by a content creator to have interactivity, such as emitting a tactile response when touched, playing a video when clicked on, changing images when a user clicks next, and so forth.

The rendering component 180 loads the platform-agnostic format and performs device-specific rendering to display the virtual objects on a particular device. The rendering component 180 receives information about virtual objects relevant to a user's current location and/or activity, each virtual object being stored in the platform-agnostic format that is independent of device type, operating system, or platform. The rendering component 180 inspects each virtual object and converts the virtual object to one or more formats supported by the client device on which the system is running. For example, Apple iPhone exposes different APIs for rendering virtual objects than Google Android does, but the rendering component isolates these differences from content creators by understanding how to move data from the platform-agnostic format to meet any device-specific requirements. The rendering component 170 also sets up any movement or interactivity defined for the virtual objects, such as rotation, playing video, and so forth.

Like the object storage component 170, the rendering component 180 may utilize a filter or plug-in architecture that allows for the later addition of device types, operating systems, or platforms not originally supported by the system to be added so that the system can render virtual objects stored in the platform-agnostic format on these new device types, operating systems, and platforms. This allows the system to continually expand and stay up to date in usefulness as users choose new platforms on which they want to experience virtual content.

The server communication component 190 sends and receives data to and from the server to store and retrieve shared virtual objects managed in the platform-agnostic format by the server. The server communication component 190 may also do work to determine which server to interact with, such as to balance load between servers, access different content experiences, or access servers provided by different operators. The server communication component 190 may use a web or other application-programming interface (API), such as a representational state transfer (REST) API, to communicate with servers to access server-side data and functionality.

The computing device on which the system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Program modules include routines, programs, objects, components, data structures, and so on that perform tasks or implement abstract data types. Typically, the functionality of the program modules may be combined or distributed as desired in various embodiments.

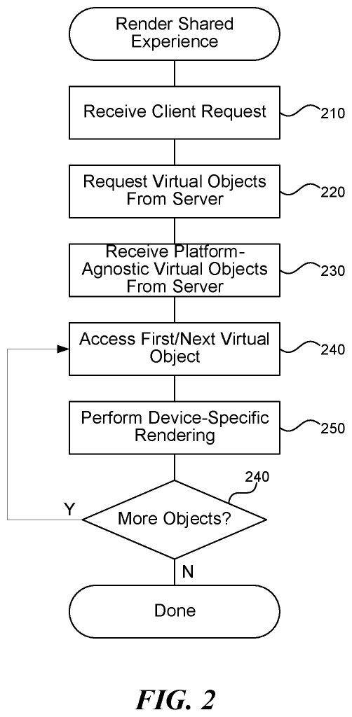

FIG. 2 is a flow diagram that illustrates processing of the shared reality system to render mixed reality virtual objects from a platform-agnostic storage format on a user's specific device, in one embodiment.

Beginning in block 210, the system receives a client request to display a mixed reality experience shared by multiple users to a user. The request may come from an application that the user runs on a mobile or other computing device, such as a smartphone or laptop computer. The user may also use a dedicated mixed reality device, such as an Oculus Go. The request may include information such as the user's location as well as other information for managing the request. For example, if the server stores a profile with persistent data about each user, the user may also supply a username and password or other authentication information for accessing the user's persistent data.

The user's location can be used by the system to decide which users are having a shared experience, such as viewing the same physical location. Being at the same location is just one way to have a shared experience, and the system and/or content creators may define shared experiences in a variety of ways. For example, users that visit the same chat room in a metaverse could also be having a shared experience, and the system can be used to render shared mixed reality objects into these types of environments as well. As another example, employees of a company could be viewing a company meeting from multiple geographic locations, but they are having a shared experience and the system can be used to render shared mixed reality objects into these types of environments also.

Continuing in block 220, the system issues a request to the server to receive virtual objects associated with the mixed reality experience shared by multiple users. The request may include any information needed for the server to determine which shared experience the user wants to access, or the server may request follow up information in one or more separate messages to the client in response to the request.

Continuing in block 230, the system receives one or more virtual objects from the server, each stored in the platform-agnostic storage format. The virtual objects may include three-dimensional data that describes any type of object that can be rendered into a three-dimensional virtual world. The three-dimensional virtual world may be fictitious or may be a three-dimensional rendering of a physical location of the user, such as is typically the case for augmented reality. The client places the received virtual objects appropriately within the three-dimensional virtual world, based on the shared experience. For example, a virtual object received from the server may contain information describing the placement of the object 50 feet above and centered within a three-dimensional model of a physical sports field the user is currently located near and able to view, such as in the case of a virtual Jumbotron.

Continuing in block 240, the system accesses the first/next virtual object received from the server. The system may read object definition information that describes the type of object, its placement within a virtual world, information to be displayed on the object (e.g., sports scores, advertisements, images, and so forth), and the like. Each virtual object is stored in a format defined by the system that is independent of any particular device, operating system, device type, content creation application format, and so on. The platform-agnostic format allows mixed reality data to be used in a uniform manner by any platform, and to be stored in a format where the server does not need to worry about which particular device will be used to consume the mixed reality data.

Continuing in block 250, the system performs device-specific rendering to render the accessed virtual object stored in the platform-agnostic storage format on the user's specific device. Device-specific rendering may include converting the virtual object from the platform-agnostic format to a format supported by APIs of the operating system of the user's specific device. This conversion happens only when the content is used so that most parts of the system do not need to be concerned with specific devices or their individual quirks. When the content is about to be rendered to the user, then the system performs any device-specific conversion and rendering of the virtual object.

Rendering may also include setting up movement and/or interactivity associated with each virtual object. For example, a virtual object may be defined by a content creator to rotate within the virtual world, to fly around in a pattern, or to respond to user touch or clicking with a pointer.

Continuing in decision block 260, if there are more virtual objects in the requested shared experience, then the system loops to block 240 to access the next virtual object, else the system completes. A shared experience could contain one or potentially many virtual objects, and although described here serially for ease of explanation, the system may employ one or more parallel algorithms for handling more than one virtual object at a time based on the available processing capabilities of the user's specific device. After block 260, these steps conclude.

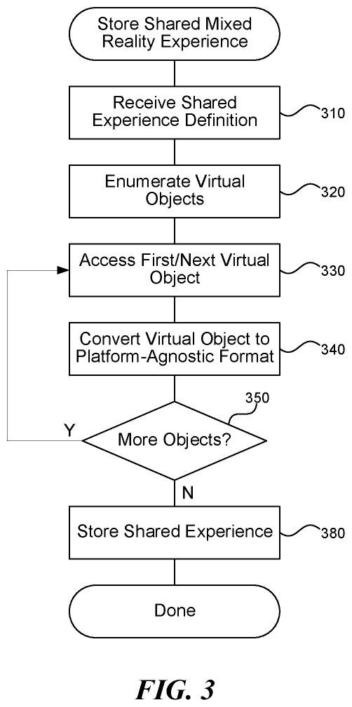

FIG. 3 is a flow diagram that illustrates processing of the shared reality system to store a shared mixed reality experience created by a content creator for multiple users, in one embodiment.

Beginning in block 310, the system receives a shared mixed reality experience definition that includes one or more virtual objects and an experience scope that determines when other users are having the same shared experience. Each virtual object represents a three-dimensional object that will be rendered into a three-dimensional model of a virtual world a user of the shared experience is viewing. The experience scope determines the parameters that determine which users are in the same experience. The scope may include a physical geographic location, a virtual room, a meeting, or other defining characteristic that associates multiple users. The scope may be determined by a shared link that all of the users use to access the shared experience, so that any users with the same link are placed by the system into the same shared experience.

Continuing in block 320, the system enumerates the virtual objects in the received shared mixed reality experience definition. A particular definition may include one or potentially many virtual objects.

Continuing in block 330, the system accesses the first/next virtual object received in the shared mixed reality experience definition. The system may read object definition information that describes the type of object, its placement within a virtual world, information to be displayed on the object (e.g., sports scores, advertisements, images, and so forth), movement/interactivity information of the object, and the like.

Continuing in block 340, the system converts the accessed virtual object into a format defined by the system that is independent of any particular device, operating system, device type, content creation application format, and so on. The platform-agnostic format allows mixed reality data to be used in a uniform manner by any platform, and to be stored in a format where the server does not need to worry about which particular device will be used to consume the mixed reality data. The incoming virtual object data may be in a platform-specific format or may be pre-converted by the client into the platform-agnostic format. If the incoming virtual object data is pre-converted, then the client did the work of converting to the platform-agnostic format and the server can just store the data. If the incoming virtual object data is not already converted, then the server performs the conversion to the platform-agnostic format and stores virtual objects in this format for serving in response to subsequent client requests. Whether the client or server performs a particular action, such as conversion, is a design and optimization decision left to particular implementors of the system.

Continuing in decision block 350, if there are more virtual objects received in the shared mixed reality experience definition, then the system loops to block 330 to access the next virtual object, else the system continues at block 360. A shared experience could contain one or potentially many virtual objects, and although described here serially for ease of explanation, the system may employ one or more parallel algorithms for handling more than one virtual object at a time based on the available processing capabilities of the computing devices on which the system is running.

Continuing in block 360, the system stores the shared mixed reality experience, including the experience scope and virtual objects in the platform-agnostic format, in a data store accessible by client devices. The data store may be a database, file server, cloud-based storage service, or any other storage facility accessible by client devices. After block 360, these steps conclude.

From the foregoing, it will be appreciated that specific embodiments of the shared reality system have been described here for purposes of illustration, but that various modifications may be made without deviating from the spirit and scope of the invention. Accordingly, the invention is not limited except as by the appended claims.

I/We claim:

1. A computer-implemented method to render mixed reality virtual objects from a platform-agnostic storage format on a user's specific device, the method comprising:
receiving a client request to display a mixed reality experience shared by multiple users to a particular user;
issuing a request to a server to receive virtual objects associated with the mixed reality experience shared by multiple users;
receiving one or more virtual objects from the server, each stored in the platform-agnostic storage format;
accessing each virtual object received from the server to read object definition information that describes the type of object, its placement within a virtual world, and information to be displayed on the object; and
performing device-specific rendering to render each accessed virtual object stored in the platform-agnostic storage format on the user's specific device,
wherein the preceding steps are performed by at least one processor.

2. The method of claim 1 wherein receiving the client request comprises receiving the user's location and using the user's location to decide which users are having a shared experience.

3. The method of claim 1 wherein receiving the client request comprises receiving information other than the user's location to decide which users are having a shared experience.

4. The method of claim 1 wherein issuing the request to the server comprises identifying which of multiple servers to which to send the request.

5. The method of claim 1 wherein receiving one or more virtual objects comprises receiving three-dimensional data that describes a type of object that can be rendered into a three-dimensional virtual world.

6. The method of claim 1 wherein receiving one or more virtual objects comprises receiving movement data that describes motion of one or more of the virtual objects.

7. The method of claim 1 wherein receiving one or more virtual objects comprises receiving interactivity data that describes one or more ways users can interact with one or more of the virtual objects.

8. The method of claim 1 wherein accessing each virtual object comprises each virtual object is stored in a format that is independent of any particular device, operating system, device type, and content creation application format.

9. The method of claim 1 wherein performing device-specific rendering comprises converting the virtual object from the platform-agnostic format to a format supported by application-programming interfaces (APIs) of an operating system of the user's specific device.

10. The method of claim 1 wherein performing device-specific rendering comprises setting up movement or interactivity associated with each virtual object.

11. A computer system for storing shared mixed reality experiences in a platform-agnostic format and rendering the experiences to specific platforms, the system comprising:
a processor and memory configured to execute software instructions embodied within the following components;
a data store component that stores mixed reality virtual objects in a platform-agnostic format supported by different operating systems and device types;
a storage request component that receives requests from one or more clients to store and retrieve mixed reality virtual objects stored in the platform-agnostic format;
a shared experience component that determines which users are part of the same shared experience and renders similar content for each user in the same shared experience to produce a similar display of mixed reality virtual objects;
an object storage component that converts device-specific representations of mixed reality virtual objects into a platform-agnostic format supported by different operating systems and device types;
a rendering component that loads the platform-agnostic format and performs device-specific rendering to display the mixed reality virtual objects on a particular device; and
a server communication component that sends and receives data to and from a server to store and retrieve shared virtual objects managed in the platform-agnostic format by the server.

12. The system of claim 11 wherein the storage request component load balances client requests so that requests from all clients are not handled by the same server.

13. The system of claim 11 wherein the shared experience component adjusts a camera angle or viewing position for each user based on each user's viewing location.

14. The system of claim 11 wherein the object storage component includes a creator application that content creators use to create and store shared experiences, and an experience application that consuming users run to view and experience the shared experiences the content creators have made for them.

15. The system of claim 11 wherein the object storage component has a plug-in architecture that allows for the later addition of formats not originally supported by the system to be added so that the system can store data from these formats in the platform-agnostic format and provide them to diverse client devices.

16. The system of claim 11 wherein the object storage component stores movement and interactivity data with each mixed reality virtual object for rendering each mixed reality virtual object by clients.

17. The system of claim 11 wherein the rendering component receives information describing mixed reality virtual objects relevant to a user's current location and activity.

18. The system of claim 11 wherein the rendering component inspects each mixed reality virtual object stored in the platform-agnostic format and converts each mixed reality virtual object to one or more formats supported by a client device on which the system is running.

19. A non-transitory computer-readable storage medium comprising instructions for controlling a computer system to store a shared mixed reality experience created by a content creator for multiple users having multiple computing device types, wherein the instructions, upon execution, cause a processor to perform actions comprising:
receiving a shared mixed reality experience definition that includes one or more virtual objects and an experience scope that determines when other users are having the same shared experience, wherein each virtual object represents a three-dimensional object that will be rendered into a three-dimensional model of a virtual world a user of the shared experience is viewing;
enumerating the virtual objects in the received shared mixed reality experience definition;
accessing each virtual object received in the shared mixed reality experience definition;
converting each accessed virtual object into a format defined by the system that is independent of any particular device, operating system, device type, and content creation application format; and
storing the shared mixed reality experience definition, including the experience scope and virtual objects converted into the platform-agnostic format, in a data store accessible by client devices.

20. The medium of claim 19 wherein the experience scope includes a shared link that all the users use to access the shared experience, so that any users with the same link are placed by the system into the same shared experience.
